(19) United States
(12) Patent Application Publication
(10) Pub. No.: US 2026/0153824 A1
(43) Pub. Date: Jun. 4, 2026

(54) IMAGE FORMING APPARATUS

(71) Applicant: CANON KABUSHIKI KAISHA, Tokyo (JP)

(72) Inventors: CHIHARU KAGEYAMA, Ibaraki (JP); SHIGEO DOI, Ibaraki (JP)

(21) Appl. No.: 19/353,735

(22) Filed: Oct. 9, 2025

(30) Foreign Application Priority Data
Dec. 3, 2024 (JP) 2024-210184

(51) Int. Cl. G03G 15/00; G03G 21/16

(52) U.S. Cl. CPC G03G 15/5016; G03G 15/80; G03G 21/1647

(57) ABSTRACT

An apparatus body; an operation portion unit including an operation portion configured to input a signal to the apparatus body; and a rotational support portion disposed in the apparatus body and configured to support rotationally the operation portion unit so that the operation portion unit pivots between a first position and a second position around a rotation axis of the rotational support portion, wherein the rotation axis of the rotational support portion is directed in a vertical direction in a state in which an installation portion of the apparatus body faces an installation surface.

### BACKGROUND

### Field of the Technology

The present disclosure relates to an image forming apparatus having an operation portion unit in which an operation panel is disposed.

### Description of the Related Art

In the related art, an operation portion unit is provided in an image forming apparatus. The operation portion unit and a main body of the image forming apparatus are electrically connected by a cable. The image forming apparatus can be operated by an operation panel or the like disposed in the operation portion unit.

When a maintenance operation is performed near the operation portion unit, the operation portion unit is moved with respect to the main body of the image forming apparatus to form a space for the maintenance operation.

In Japanese Patent Application Laid-Open No. 2004-54173, positions of left and right ends of an operation portion unit are restricted by a part of a main body of an image forming apparatus, and the operation portion unit is moved in parallel with the main body of the image forming apparatus. When the operation portion unit is moved forward in parallel from the fixing position and temporarily held at a temporary holding position, a space for electrical connection is formed between a rear side end of the operation portion unit and a front side end of the main body of the image forming apparatus.

However, in the technique of Japanese Patent Application Laid-Open No. 2004-54173, the operation portion unit is moved forward in parallel. Therefore, there was a problem that the workability was poor in a case where an operator tried to access a maintenance target from the front surface.

### SUMMARY

According to an aspect of the present disclosure, an apparatus body; an operation portion unit including an operation portion configured to input a signal to the apparatus body; and a rotational support portion disposed in the apparatus body and configured to support rotationally the operation portion unit so that the operation portion unit pivots between a first position and a second position around a rotation axis of the rotational support portion, wherein the rotation axis of the rotational support portion is directed in a vertical direction in a state in which an installation portion of the apparatus body faces an installation surface.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a full-color and monochrome image forming apparatus.

FIG. 2 is a cross-sectional view of the full-color image forming apparatus.

FIG. 3A is a cross-sectional view of a full-color image forming portion, and

FIGS. 3B and 3C are cross-sectional views of an image creation station.

FIG. 4 is a cross-sectional view of the monochrome image forming apparatus.

FIG. 5A is a cross-sectional view of a monochrome image forming portion, and FIG. 5B is a cross-sectional view of an image creation station.

FIG. 6A is a perspective view of an operation panel as viewed from the panel portion side, FIG. 6B is a perspective view of the operation panel as viewed from the back surface side of the panel portion, and FIG. 6C is a perspective view of a state in which a back cover is removed from the operation panel, as viewed from the back surface side of the panel portion.

FIG. 7 is a diagram showing a state in which cables of an operation portion unit are disposed to extend over the operation portion unit and a main body of the image forming apparatus.

FIG. 8 is a diagram showing cable holding portions on a left side surface of the apparatus body.

FIG. 9A is a perspective view of the interior of the left side of the operation portion unit, and FIG. 9B is a perspective view of an operation portion left lid.

FIG. 10A is a perspective view of the interior of the right side of the operation portion unit, and FIG. 10B is a perspective view of an operation portion right lid.

FIG. 11 is a perspective view of an upper cover.

FIG. 12 is a perspective view of an original reading device front cover.

FIG. 13 is a perspective view when an operation portion base plate and an operation portion sub-base plate are mounted on main body sub-frames.

FIGS. 14A, 14B, and 14C are schematic diagrams of fastening screws.

FIGS. 15A, 15B, and 15C are enlarged perspective views of the vicinity of a bent portion 11 of the main body sub-frame.

FIGS. 16A, 16B, and 16C are diagrams in which the original reading device front cover and the upper cover are removed.

FIG. 17 is a diagram in a case where a shape of a rotational support portion is cylindrical and a shape of an opening of the operation portion base plate is a teardrop hole.

FIG. 18 is a diagram schematically showing the operation portion unit, the cable holding portion, a rotation center, and a right rear end of the operation portion unit near an access space.

FIG. 19 is a schematic diagram of a curved portion of the cable and the cable holding portions.

### DESCRIPTION OF THE EMBODIMENTS

Hereinafter, an embodiment of an image forming apparatus according to the present disclosure will be described in detail with reference to the drawings. Note that dimensions, materials, relative positions, and the like of components of the image forming apparatus described below are not intended to limit the scope of the present disclosure unless otherwise specified. In addition, components denoted by the same reference numerals in the drawings have the same configuration or action, and redundant description thereof will be appropriately omitted.

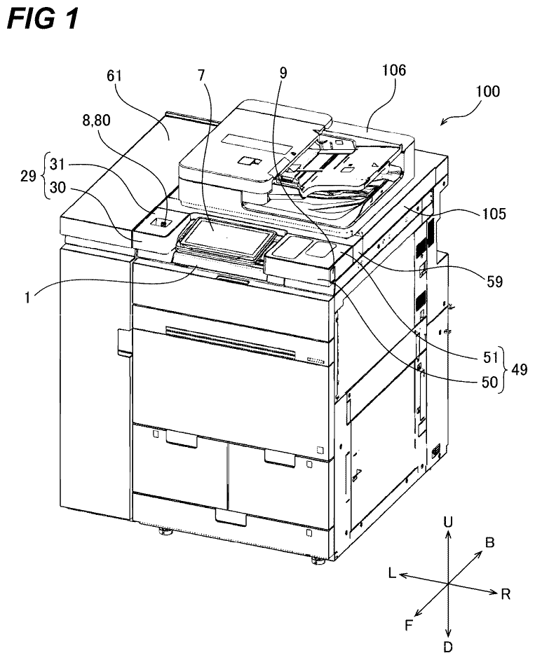

An upward direction U, a downward direction D, a rightward direction R, a leftward direction L, a backward direction B, and a forward direction F used in the following description are defined as shown in FIG. 1. A near side (front surface side, front side) facing an image forming apparatus 100 shown in FIG. 1 is defined as the forward direction F, a deep side (back surface side, rear side) as the backward direction B, a left side as the leftward direction L, a right side as the rightward direction R, an upper side as the upward direction U, and a lower side as the downward direction D.

### First Embodiment

### (Image Forming Apparatus)

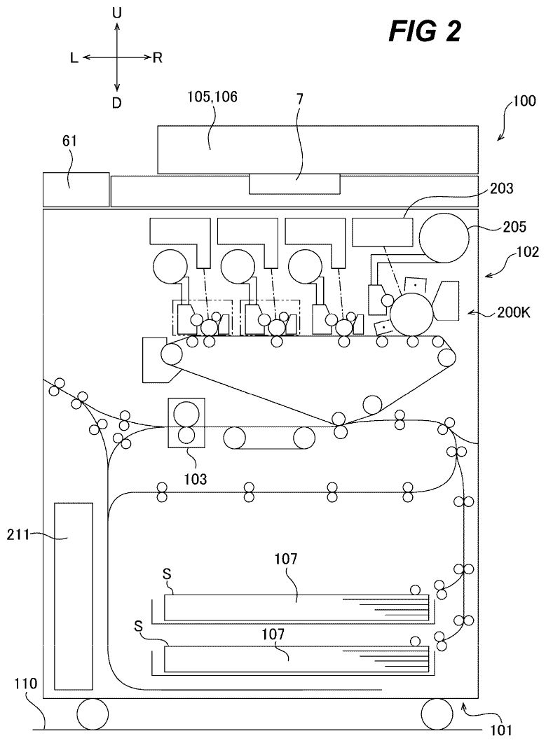

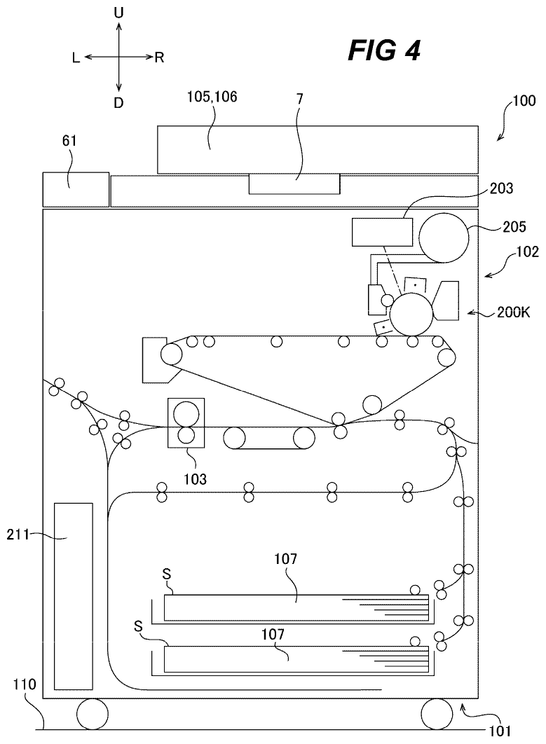

FIG. 1 is a perspective view of a full-color and monochrome image forming apparatus 100. FIG. 2 is a cross-sectional view of the full-color image forming apparatus 100. FIG. 4 is a cross-sectional view of the monochrome image forming apparatus 100.

The image forming apparatus 100 has a feeding portion 107, an image forming portion 102, and a fixing portion 103. The image forming portion 102 forms a toner image on a recording medium (hereinafter, referred to as a sheet) S fed from the feeding portion 107. The fixing portion 103 fixes the toner image formed by the image forming portion 102 to the sheet S. Above the image forming portion 102, an automatic original feeding portion 106 is provided on the deep side, and an original reading device 105 is provided therebelow. An operation portion unit 1 that is used by an operator to operate the image forming apparatus 100 is provided on the near side. That is, the operation portion unit 1 is provided on the near side of the original reading device 105.

The automatic original feeding portion 106 feeds originals one by one from a bundle of stacked originals to the original reading device 105. The original reading device 105 reads an image of the original fed by the automatic original feeding portion 106 or an image of the original placed on a platen glass (not shown). The original reading device 105 and the automatic original feeding portion 106 are optionally connected to the image forming portion 102.

The feeding portion 107 is disposed upstream of the image forming portion 102 in a sheet conveying direction. The feeding portion 107 has a plurality of sheet storage portions. Instead of the feeding portion 107, a manual feeding portion (not shown) or a long feeding portion (not shown) capable of housing long sheets may be selectively connected to the image forming portion 102. In addition to the feeding portion 107, another large-capacity feeding portion (not shown), manual feeding portion (not shown), or long feeding portion may be selectively connected in multiple connections. A sheet on which an image is formed by the image forming apparatus 100 is discharged to the outside of the image forming apparatus 100 from a discharge tray (not shown) provided in the image forming apparatus 100, a finisher connected to the image forming apparatus 100, or the like.

### (Full-Color Image Forming Portion)

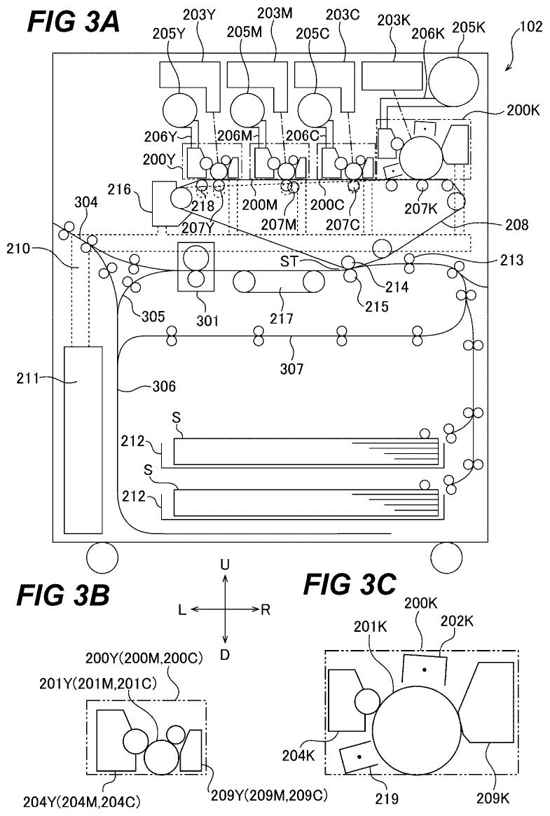

The image forming portion 102 in the image forming apparatus 100 of the present embodiment will be described with reference to FIGS. 3A to 3C. FIG. 3A is a cross-sectional view of the full-color image forming portion 102. The image forming portion 102 has a yellow image creation station 200Y, a magenta image creation station 200M, a cyan image creation station 200C, and a black image creation station 200K as image forming units.

The image forming portion 102 has laser scanners 203Y, 203M, 203C, and 203K, toner bottles (toner housing containers) 205Y, 205M, 205C, and 205K, and toner replenishment paths 206Y, 206M, 206C, and 206K.

The subscripts Y, M, C, and K of the reference numerals indicate yellow, magenta, cyan, and black, respectively. In the following description, the subscripts Y, M, C, and K may be omitted if not particularly necessary.

Furthermore, the image forming portion 102 has primary transfer rollers 207Y, 207M, 207C, and 207K, an intermediate transfer belt 208, a toner recovery path 210, a recovery toner container 211, and a sheet storage portion 212. Moreover, the image forming portion 102 has a registration roller 213, an inner secondary transfer roller 214, an outer secondary transfer roller 215, an intermediate transfer belt cleaner 216, a pre-fixing conveying belt 217, and a primary transfer auxiliary roller 218. A nip portion between the inner secondary transfer roller 214 and the outer secondary transfer roller 215 forms a secondary transfer portion ST. The yellow image creation station 200Y forms a yellow (Y) toner image. The magenta image creation station 200M forms a magenta (M) toner image. The cyan image creation station 200C forms a cyan (C) toner image. The yellow image creation station 200Y, the magenta image creation station 200M, and the cyan image creation station 200C have the same structure.

FIG. 3B is a diagram showing the yellow image creation station 200Y. In FIG. 3B, the reference numerals indicating the structures of the magenta image creation station 200M and the cyan image creation station 200C are shown in the brackets. The yellow image creation station 200Y (200M, 200C) has a photosensitive drum 201Y (201M, 201C). A primary charger 202Y (202M, 202C), a development device 204Y (204M, 204C), and a photosensitive drum cleaner 209Y (209M, 209C) are provided around the photosensitive drum 201Y (201M, 201C). The primary charger 202Y (202M, 202C) is a charging roller. FIG. 3C is a diagram showing the black image creation station 200K. The black image creation station 200K forms a black (K) toner image. The black image creation station 200K has a photosensitive drum 201K. A primary charger 202K, a development device 204K, a pre-transfer charger 219, and a photosensitive drum cleaner 209K are provided around the photosensitive drum 201K. The primary charger 202K is a corona charger.

### (Full-Color Image Forming Process)

Image forming processes in the yellow image creation station 200Y, the magenta image creation station 200M, the cyan image creation station 200C, and the black image creation station 200K are substantially the same except for the toner color. Hereinafter, an image forming process in the yellow image creation station 200Y will be described with reference to FIG. 3B. The surface of the photosensitive drum 201Y in the yellow image creation station 200Y is uniformly charged by the primary charger 202Y. The laser scanner 203Y emits laser light to the photosensitive drum 201Y according to image data to form an electrostatic latent image on the surface of the photosensitive drum 201Y. The development device 204Y develops the electrostatic latent image with a yellow toner to form a yellow toner image on the surface of the photosensitive drum 201Y. In a case where the toner in the development device 204Y is consumed due to the development, the yellow toner is appropriately supplied from the toner bottle 205Y to the development device 204Y via the toner replenishment path 206Y. The toner image on the surface of the photosensitive drum 201Y is transferred onto the intermediate transfer belt 208 by applying a predetermined pressure and a predetermined electrostatic load bias by the primary transfer roller 207Y. After the transfer, the toner slightly remaining on the photosensitive drum 201Y is removed by the photosensitive drum cleaner 209Y.

The toner removed by the photosensitive drum cleaner 209Y is recovered in the recovery toner container 211 via the toner recovery path 210. Similarly, a magenta toner image, a cyan toner image, and a black toner image are formed by the magenta image creation station 200M, the cyan image creation station 200C, and the black image creation station 200K, respectively. The magenta toner image, the cyan toner image, and the black toner image are sequentially transferred onto the intermediate transfer belt 208, and the toner images of four colors are superimposed on the intermediate transfer belt 208.

Meanwhile, sheets S are fed one by one from the sheet storage portion 212 of the image forming portion 102 and conveyed to the registration roller 213. A front end of the sheet S abuts on the nip portion of the stopped registration roller 213, a loop is formed in the sheet S, and the skew feeding of the sheet S is corrected. Thereafter, the registration roller 213 starts to rotate and conveys the sheet S to the secondary transfer portion ST so that the front end of the toner image on the intermediate transfer belt 208 and the front end of the sheet S coincide at the secondary transfer portion ST. The toner image on the intermediate transfer belt 208 is transferred to the sheet S by applying a predetermined pressure and a predetermined electrostatic load bias by the secondary transfer portion ST. After the transfer, the toner slightly remaining on the intermediate transfer belt 208 is removed by the intermediate transfer belt cleaner 216. The toner removed by the intermediate transfer belt cleaner 216 is recovered in the recovery toner container 211 via the toner recovery path 210. The sheet S to which the toner image has been transferred is conveyed to the fixing portion 103 by the pre-fixing conveying belt 217.

### (Fixing Portion)

As shown in FIG. 3A, a fixer 301 heats and pressurizes the toner image on the sheet S conveyed from the pre-fixing conveying belt 217 to fix the toner image on the sheet S.

The fixing portion 103 has the fixer 301, a discharge conveying path 304, a discharge reversing portion 305, a duplex reversing portion 306, and a duplex conveying path 307.

In a case where the sheet S is turned upside down and discharged, the sheet S is switched back by the discharge reversing portion 305, the front end and the rear end of the sheet S are switched, and the sheet S is discharged via the discharge conveying path 304 in a state in which the front and back sides of the sheet S are reversed.

In addition, in a case where images are formed on both surfaces of the sheet S, the sheet S on which the image of the first surface has been formed is switched back by the duplex reversing portion 306, the front end and the rear end of the sheet S are switched, and the sheet S is conveyed to the duplex conveying path 307 in a state in which the front and back sides of the sheet S are reversed. Thereafter, the sheet S is conveyed to the registration roller 213 in order with a subsequent sheet fed from the sheet storage portion 212 of the image forming portion 102. Then, an image is formed on the second surface of the sheet S by the same image forming process as in the case of the first surface, and the sheet S is discharged via the discharge conveying path 304.

The full-color image forming portion 102 has, as described above, the yellow image creation station 200Y, the magenta image creation station 200M, the cyan image creation station 200C, and the black image creation station 200K as image forming units. The full-color image forming apparatus can be used as a monochrome image forming apparatus, and in a case where the full-color image forming apparatus is used as a monochrome image forming apparatus, the yellow image creation station 200Y, the magenta image creation station 200M, and the cyan image creation station 200C of the full-color image forming apparatus are not mounted, and only the black image creation station 200K is mounted.

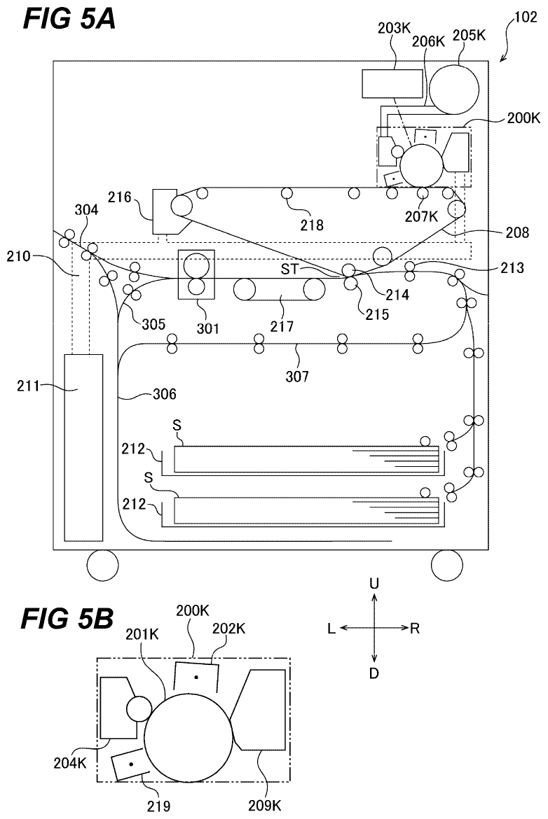

The fixing portion 103 in the monochrome image forming apparatus shown in FIG. 5A is configured in the same manner as in the full-color image forming apparatus shown in FIG. 3A. Here, members having the same functions are denoted by the same reference numerals, and description thereof will be omitted.

### (Monochrome Image Forming Portion)

The image forming portion 102 in the image forming apparatus 100 of the present embodiment will be described with reference to FIGS. 5A and 5B. FIG. 5A is a cross-sectional view of the monochrome image forming portion 102.

The image forming portion 102 has an image creation station 200 as an image forming unit. The image forming portion 102 has a laser scanner 203, a toner bottle (toner housing container) 205, and a toner replenishment path 206. Furthermore, the image forming portion 102 has a primary transfer roller 207, an intermediate transfer belt 208, a toner recovery path 210, a recovery toner container 211, and a sheet storage portion 212. Moreover, the image forming portion 102 has a registration roller 213, an inner secondary transfer roller 214, an outer secondary transfer roller 215, an intermediate transfer belt cleaner 216, a pre-fixing conveying belt 217, and a primary transfer auxiliary roller 218.

FIG. 5B is a diagram showing the image creation station 200. In FIG. 5B, the image creation station 200 forms a toner image. The image creation station 200 has a photosensitive drum 201. A primary charger 202, a development device 204, a pre-transfer charger 219, and a photosensitive drum cleaner 209 are provided around the photosensitive drum 201. The primary charger 202 is a corona charger.

### (Monochrome Image Forming Process)

Hereinafter, an image forming process in the image creation station 200 will be described with reference to FIG. 5B. The surface of the photosensitive drum 201 in the image creation station 200 is uniformly charged by the primary charger 202. The laser scanner 203 emits laser light to the photosensitive drum 201 according to image data to form an electrostatic latent image on the surface of the photosensitive drum 201. The development device 204 develops the electrostatic latent image with a toner to form a toner image on the surface of the photosensitive drum 201. In a case where the toner in the development device 204 is consumed due to the development, the toner is appropriately supplied from the toner bottle 205 to the development device 204 via the toner replenishment path 206. The toner image on the surface of the photosensitive drum 201 is transferred onto the intermediate transfer belt 208 by applying a predetermined pressure and a predetermined electrostatic load bias by the primary transfer roller 207. After the transfer, the toner slightly remaining on the photosensitive drum 201 is removed by the photosensitive drum cleaner 209. The toner removed by the photosensitive drum cleaner 209 is recovered in the recovery toner container 211 via the toner recovery path 210. The toner image is transferred onto the intermediate transfer belt 208, and the toner image is placed on the intermediate transfer belt 208.

Meanwhile, sheets S are fed one by one from the sheet storage portion 212 of the image forming portion 102 and conveyed to the registration roller 213. A front end of the sheet S abuts on the nip portion of the stopped registration roller 213, a loop is formed in the sheet S, and the skew feeding of the sheet S is corrected. Thereafter, the registration roller 213 starts to rotate and conveys the sheet S to the secondary transfer portion ST so that the front end of the toner image on the intermediate transfer belt 208 and the front end of the sheet S coincide at the secondary transfer portion ST. The toner image on the intermediate transfer belt 208 is transferred to the sheet S by applying a predetermined pressure and a predetermined electrostatic load bias by the secondary transfer portion ST. After the transfer, the toner slightly remaining on the intermediate transfer belt 208 is removed by the intermediate transfer belt cleaner 216. The toner removed by the intermediate transfer belt cleaner 216 is recovered in the recovery toner container 211 via the toner recovery path 210. The sheet S to which the toner image has been transferred is conveyed to the fixing portion 103 by the pre-fixing conveying belt 217.

In the present embodiment, the monochrome image forming apparatus has been described as an example of the image forming apparatus. However, the present disclosure is not limited to the monochrome image forming apparatus, but may also be applied to full-color or monochrome image forming apparatuses.

### (Operation Portion Unit)

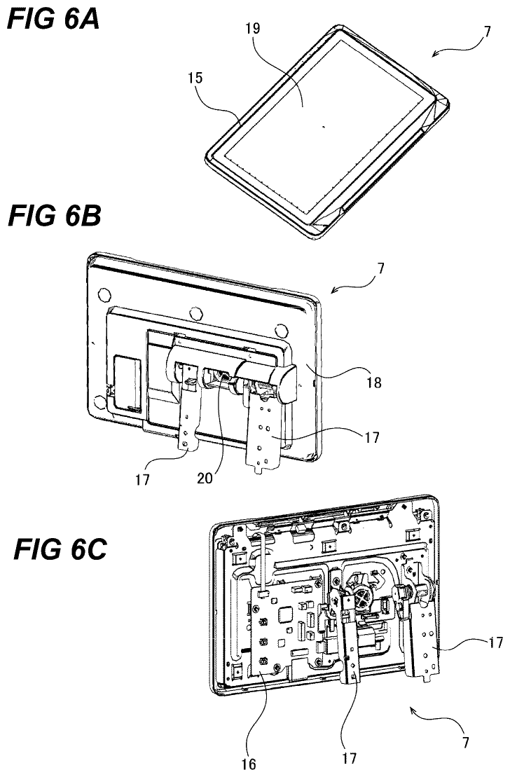

Next, a configuration of the operation portion unit 1 will be described with reference to FIGS. 1 and 6A to 6C. FIG. 6A is a perspective view of an operation panel 7 as viewed from the panel portion 15 side. FIG. 6B is a perspective view of the operation panel 7 as viewed from the back surface side of the panel portion 15. FIG. 6C is a perspective view of a state in which an operation portion back cover 18 is removed from the operation panel 7, as viewed from the back surface side of the panel portion 15.

The operation portion unit 1 is movably attached to a main body frame 3 and main body sub-frames 10a and 10b, serving as an apparatus body (chassis) of the image forming apparatus 100. The operation portion unit 1 has the operation panel 7 and a user access portion different from the operation panel. The operation panel 7 is an operation portion that is disposed in the operation portion unit 1 and can receive input of a signal to the apparatus body. A user access portion different from the operation panel is also disposed in the operation portion unit 1. The operation portion unit 1 has a user USB connection portion 8 and a power supply unit portion 9 as user access portions different from the operation panel. The operation portion unit 1, in which the operation panel 7, the user USB connection portion 8, and the power supply unit portion 9 are integrated, is movably provided on the apparatus body of the image forming apparatus 100.

### (Operation Panel)

As shown in FIG. 1, the operation panel 7 is disposed substantially at the center of the operation portion unit 1, and is disposed between the user USB connection portion 8 and the power supply unit portion 9.

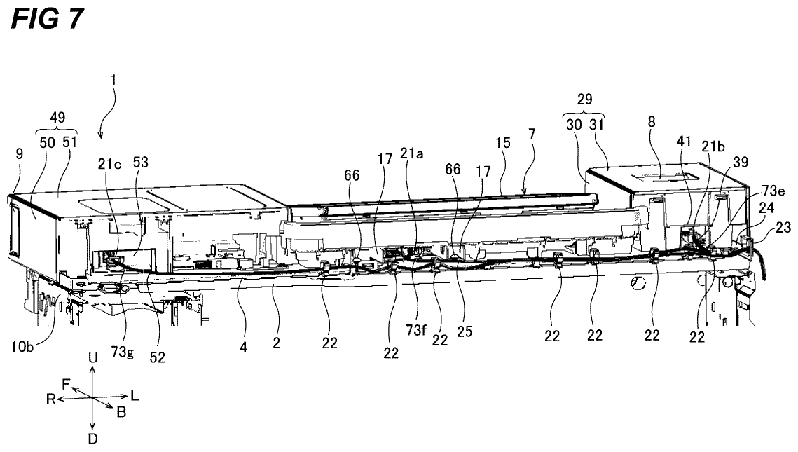

As shown in FIGS. 6A to 6C, the operation panel 7 has the panel portion 15, a substrate 16, an operation portion frame 17, and the operation portion back cover 18. The panel portion 15 has a substantially rectangular flat plate shape, and has a display portion 19 on a surface on the front surface side of the image forming apparatus 100. The substrate 16 is fastened and fixed by screws along the back side of the panel portion 15, and is connected to the display portion 19 to transmit and receive electric signals. The substrate 16 is provided with a connector for connecting a cable 25 that electrically connects a control substrate (not shown) of the apparatus body and the operation panel 7. The substrate 16 is an electric substrate that controls the panel portion 15 based on a signal from the controller of the main body of the image forming apparatus. The operation portion frame 17 is fastened and fixed to the back side of the panel portion 15 by screws. As shown in FIG. 7, the operation portion frame 17 of the operation panel 7 is fastened and fixed to an operation portion sub-base plate 4 by screws 66.

As shown in FIG. 6B, the operation portion back cover 18 is fastened to the back side of the panel portion 15 by screws to cover the substrate 16 and a part of the operation portion frame 17. The operation portion back cover 18 has a cable-passing opening portion 20 through which the cable 25 connected to the connector of the substrate 16 passes.

As shown in FIG. 7, the cable 25 that has passed through the cable-passing opening portion 20 passes through a cable holding portion 21a disposed in the operation portion sub-base plate 4, and heads toward the deep side of the operation portion sub-base plate 4. The cable 25 further passes through a plurality of cable holding portions 22 disposed on the deep side of an operation portion base plate 2, heads toward the left side, passes through a cable holding portion 23 provided in an operation portion base plate-bent portion 24, and heads toward the left side surface of the apparatus body.

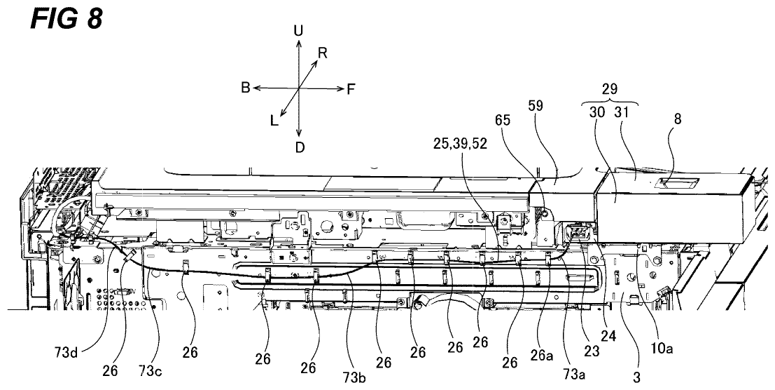

FIG. 8 is a diagram showing cable holding members on the left side surface of the apparatus body. As shown in FIG. 8, after passing through the cable holding portion 23, the cable 25 passes through a plurality of cable holding portions 26 provided on the left side surface of the apparatus body, heads from the front side toward the rear side, and is connected to the connector of the control substrate (not shown) disposed on the rear side of the apparatus body.

### (User USB Connection Portion)

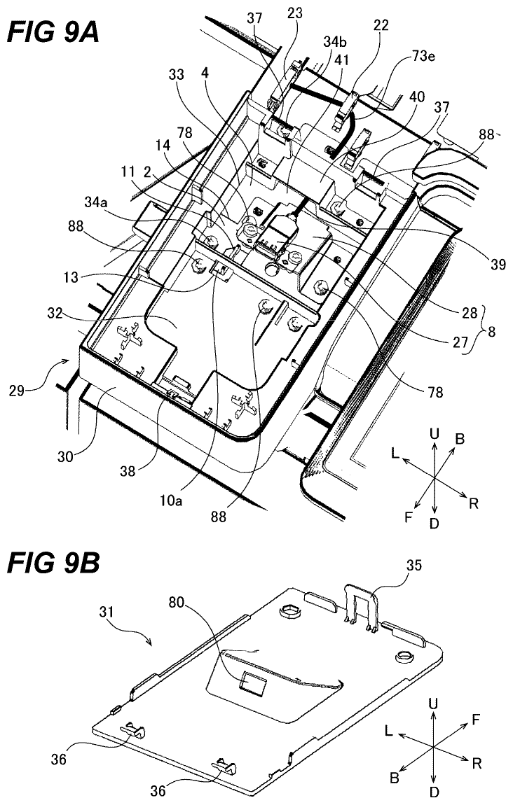

As shown in FIG. 1, the user USB connection portion 8 is disposed on the left side of the operation panel 7. As shown in FIG. 9A, the user USB connection portion 8 has a USB connection connector portion 27 and a USB connection support plate 28. The USB connection connector portion 27 and the USB connection support plate 28 are fastened and fixed by screws, the USB connection support plate 28 is further fastened and fixed to the operation portion sub-base plate 4 by screws, and the user USB connection portion 8 is disposed in the operation portion unit 1. The user USB connection portion 8 is disposed in an operation portion left-case portion 29 on the left side of the operation panel 7.

As shown in FIG. 1, the operation portion left-case portion 29 has a substantially rectangular box shape, and includes an operation portion left case 30 having a bottom surface and side surfaces of the operation portion left-case portion 29 and an operation portion left lid 31 having an upper surface.

As shown in FIG. 9A, an operation portion left-case bottom surface 32 of the operation portion left case 30 is fastened and fixed to the operation portion sub-base plate 4 by screws 88. The operation portion left-case bottom surface 32 has an operation portion left-case bottom surface opening 33. The operation portion left-case bottom surface opening 33 is disposed at a position avoiding the user USB connection portion 8, a screw 34a that fastens the operation portion base plate 2 to the main body frame 3, and a bent portion 11 of the main body frame 3.

FIG. 9B is a perspective view of the operation portion left lid 31. As shown in FIG. 9B, the operation portion left lid 31 has a snap fit 35 on the front side and a shaft nipping portion 36 on the rear side.

As shown in FIG. 9A, the operation portion left case 30 has a shaft portion 37 corresponding to the shaft nipping portion 36 on the rear side, and a projection portion 38 corresponding to the snap fit 35 on the front side.

The shaft portion 37 of the operation portion left case 30 is nipped by the shaft nipping portion 36 of the operation portion left lid 31, and the snap fit 35 of the operation portion left lid 31 is engaged with the projection portion 38 of the operation portion left case 30 to fix the operation portion left lid 31 to the operation portion left case 30.

By releasing the engagement with the projection portion 38 by bending the snap fit 35, the operation portion left lid 31 can be removed from the image forming apparatus.

In addition, as shown in FIG. 9B, the operation portion left lid 31 has a USB connection opening 80 at a position corresponding to the USB connection port of the USB connection connector portion 27. In a case where the operation portion left lid 31 is fixed to the operation portion left case 30, a user can connect a USB to the USB connection port of the USB connection connector portion 27.

As shown in FIG. 9A, a USB connection cable 39 is connected to the USB connection connector portion 27. The operation portion left-case bottom surface 32 of the operation portion left case 30 has a bottom surface protrusion portion 40 protruding upward in a U-shape on the rear side. The bottom surface protrusion portion 40 forms a USB connection cable-passing space 41, through which the USB connection cable 39 can pass, in a part between the operation portion sub-base plate 4 and the operation portion left-case bottom surface 32.

As shown in FIG. 7, the USB connection cable 39 passes through the USB connection cable-passing space 41 and a cable holding portion 21b of the operation portion sub-base plate 4, and then heads toward the deep side of the operation portion sub-base plate 4. The USB connection cable 39 further passes through the plurality of cable holding portions 22 disposed on the deep side of the operation portion base plate 2, heads toward the left side, passes through the cable holding portion 23 provided in the operation portion base plate-bent portion 24, and heads toward the left side surface of the apparatus body.

Thereafter, as shown in FIG. 8, the USB connection cable 39 passes through the plurality of cable holding portions 26 provided on the left side surface of the apparatus body, heads from the front side toward the rear side, and is connected to the connector of the control substrate (not shown) disposed on the rear side of the apparatus body.

### (Power Supply Unit Portion)

As shown in FIG. 1, the power supply unit portion 9 is disposed on the right side of the operation panel 7. The power supply unit portion 9 is disposed in an operation portion right-case portion 49 on the right side of the operation panel 7.

As shown in FIG. 1, the operation portion right-case portion 49 has a substantially rectangular box shape, and includes an operation portion right case 50 having a bottom surface and side surfaces of the operation portion right-case portion 49 and an operation portion right lid 51 having an upper surface.

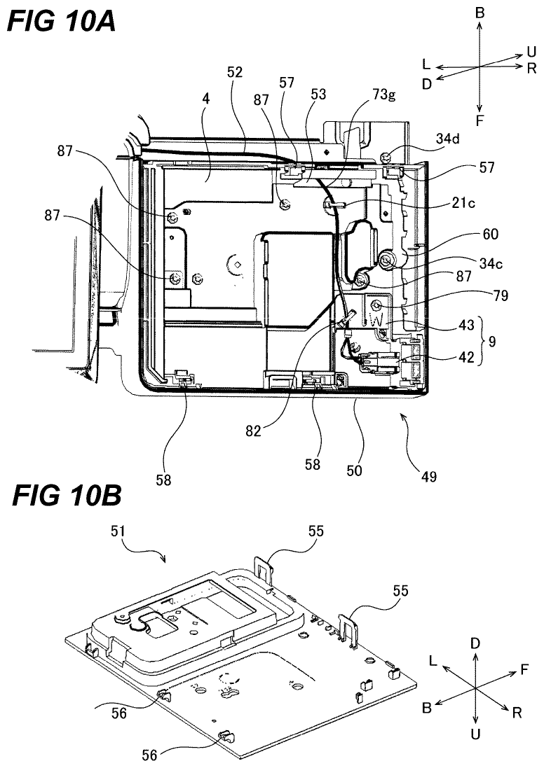

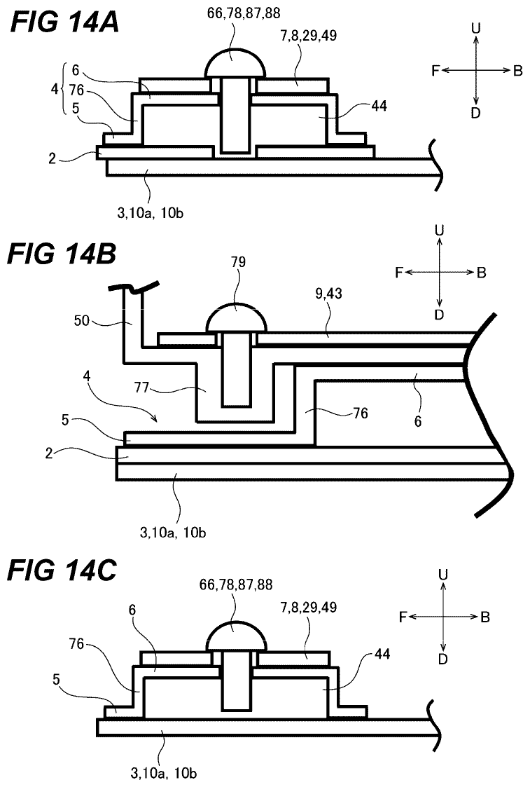

As shown in FIG. 10A, the power supply unit portion 9 includes a power switch 42 and a power switch support plate 43. The power switch support plate 43 is provided with a screw fastening hole, and is fastened to a self-tap 77 (FIG. 14B) in the bottom surface of the operation portion right case 50 by a screw 79 and fixed to the operation portion right case 50. The operation portion right case 50 has an opening at a position corresponding to the switch that is a user pressing portion of the power switch 42, and a user can press the power switch when the power switch support plate 43 is fixed to the operation portion right case 50. In addition, the bottom surface of the operation portion right case 50 is provided with an opening 60 for accessing a screw 34c that fastens the operation portion base plate 2 to the main body sub-frame 10b.

FIG. 10B is a perspective view of the operation portion right lid. As shown in FIG. 10B, the operation portion right lid 51 has a snap fit 55 on the front side and a shaft nipping portion 56 on the rear side. As shown in FIG. 10A, the operation portion right case 50 has a shaft portion 57 corresponding to the shaft nipping portion 56 on the rear side, and a projection portion 58 corresponding to the snap fit 55 on the front side.

The shaft portion 57 of the operation portion right case 50 is nipped by the shaft nipping portion 56 of the operation portion right lid 51, and the snap fit 55 of the operation portion right lid 51 is engaged with the projection portion 58 of the operation portion right case 50 to fix the operation portion right lid 51 to the operation portion right case 50.

By releasing the engagement with the projection portion 58 by bending the snap fit 55, the operation portion right lid 51 can be removed from the image forming apparatus.

As shown in FIG. 10A, a power switch cable 52 is connected to the power switch 42. The rear surface of the operation portion right case 50 is provided with a power switch cable-passing opening 53 for passing the power switch cable 52. The power switch cable 52 passes through a cable holding portion 82 provided on the power switch support plate 43 and a cable holding portion 21c provided on the bottom surface of the operation portion right case 50, passes through the power switch cable-passing opening 53, and heads toward the deep side of the main body. As shown in FIG. 7, the power switch cable 52 passes through the plurality of cable holding portions 22 disposed on the deep side of the operation portion base plate 2, heads toward the left side, passes through the cable holding portion 23 provided in the operation portion base plate-bent portion 24, and heads toward the left side surface of the apparatus body.

Thereafter, as shown in FIG. 8, the power switch cable 52 passes through the plurality of cable holding portions 26 provided on the left side surface of the apparatus body, heads from the front side toward the rear side, and is connected to the connector of the control substrate (not shown) disposed on the rear side of the apparatus body.

The cable of the unit included in the operation portion unit 1 passes through the cable holding portion 23 provided in the operation portion base plate-bent portion 24, heads toward the left side surface of the apparatus body, passes through the cable holding portion 26 provided on the left side surface of the apparatus body, heads from the front side toward the rear side, and is connected to the connector of the control substrate (not shown) disposed on the rear side of the apparatus body.

In addition, here, a configuration is adopted in which all the cables of the units included in the operation portion unit 1 pass through the same cable holding portions, but the present invention is not limited thereto. For example, a configuration may be adopted in which the cables of the units included in the operation portion unit 1 may pass through different cable holding portions, or some cables of the units included in the operation portion unit 1 may pass through the same cable holding portions.

### (Upper Cover)

As shown in FIG. 1, an upper cover 61 is provided on the left side of the operation portion unit 1, and the upper cover 61 covers the recovery toner container 211, the discharge conveying path 304, and the discharge conveying path substrate.

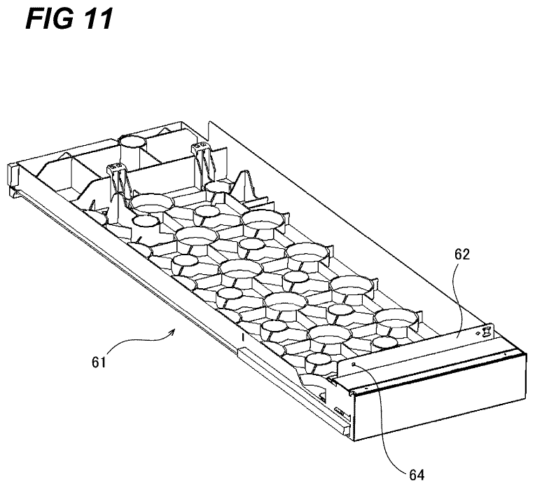

FIG. 11 is a perspective view of the upper cover 61. As shown in FIG. 11, an upper cover rib 62 is disposed to extend vertically downward in front of a lower surface of the upper cover 61, and a screw fastening hole 64 for fastening to the main body is provided on a surface of the upper cover rib. In the main body of the image forming apparatus, a screw hole (not shown) is disposed at a position corresponding to the screw fastening hole 64 on the surface of the upper cover rib, and the upper cover 61 can be fixed to the main body of the image forming apparatus by fastening the screw fastening hole 64 on the surface of the upper cover rib to the screw hole by a screw. In addition, the upper cover 61 can be removed from the main body of the image forming apparatus by removing the screw.

### (Front Cover)

As shown in FIG. 1, an original reading device front cover 59 is provided between the original reading device 105 and the operation portion unit 1. The original reading device front cover 59 covers the cable holding portion 23 provided in the operation portion base plate-bent portion 24, the cable holding portion 22 provided in the operation portion base plate 2, the operation portion base plate 2, and the screws 34b and 34d (FIGS. 9A and 10A) of the main body frame 3.

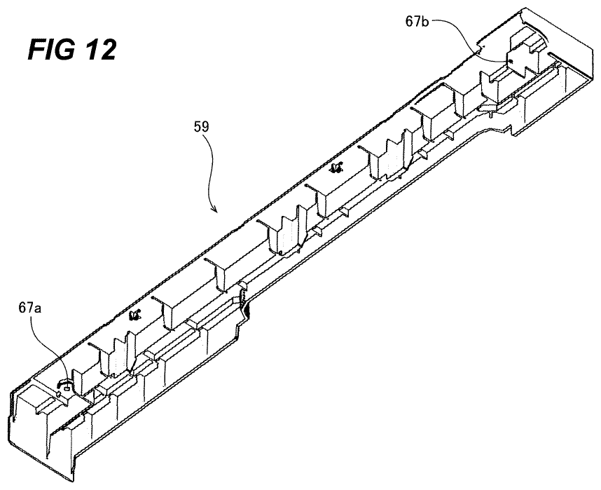

FIG. 12 is a perspective view of the original reading device front cover 59. As shown in FIG. 12, screw fastening holes 67a and 67b for fastening to the main body are provided on an upper surface and a side surface of the original reading device front cover 59. In the main body of the image forming apparatus, screw holes are disposed at positions corresponding to the screw fastening holes 67a and 67b of the original reading device front cover 59. The original reading device front cover 59 can be fixed to the main body of the image forming apparatus by fastening the screw fastening holes 67a and 67b of the original reading device front cover 59 to the screw holes of the main body of the image forming apparatus by screws. In addition, the original reading device front cover 59 can be removed from the main body of the image forming apparatus by removing the screws.

### (Base Plate of Operation Portion Unit)

Here, the base plate of the operation portion unit 1 will be described.

As shown in FIG. 1, the operation portion unit 1 is provided on the front side of the apparatus body of the image forming apparatus 100. The operation portion unit 1 is movably attached to the main body frame 3 and the main body sub-frames 10a and 10b, serving as an apparatus body (chassis) of the image forming apparatus 100. FIG. 7 is a perspective view of the operation portion unit 1 as viewed from the back surface. As shown in FIG. 7, the operation portion unit 1 has the operation portion base plate 2 and the operation portion sub-base plate 4 as base plates.

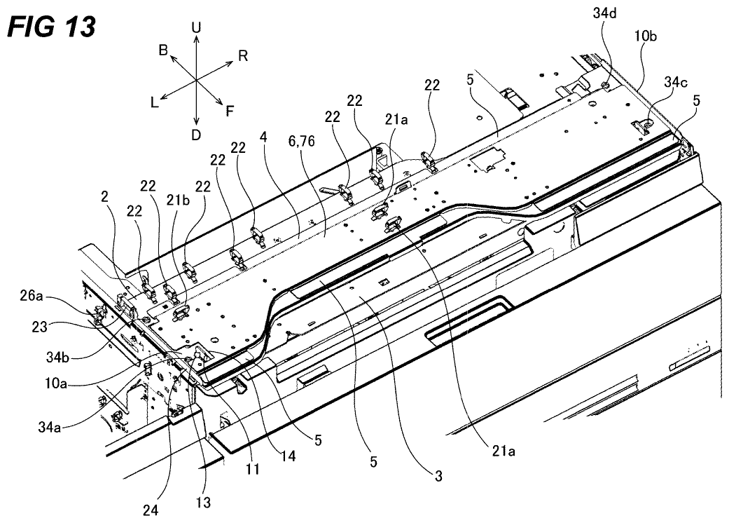

FIG. 13 is a perspective view when the operation portion base plate 2 and the operation portion sub-base plate 4 are mounted on the main body sub-frames 10a and 10b. As shown in FIG. 13, the operation portion base plate 2 is fixed by being fastened to the main body sub-frames 10a and 10b, serving as the chassis of the main body of the image forming apparatus, by screws 34a, 34b, 34c, and 34d.

The operation portion sub-base plate 4 is welded to the operation portion base plate 2. By placing a hat-bent-shaped portion 76 on the operation portion sub-base plate 4, a contact portion 5 in which surfaces of the operation portion base plate 2 and the operation portion sub-base plate 4 are in contact with each other, and a non-contact portion 6 in which the surfaces of the operation portion base plate 2 and the operation portion sub-base plate 4 are not in contact with each other and which has a space are provided. The operation portion base plate 2 and the operation portion sub-base plate 4 are welded to each other in the contact portion 5.

In the present embodiment, the operation portion base plate 2 and the operation portion sub-base plate 4 are fixed by welding, but the present invention is not limited thereto. For example, the operation portion base plate 2 and the operation portion sub-base plate 4 may be fixed by screw fastening or the like.

As shown in FIG. 1, the operation panel 7, the user USB connection portion 8, the power supply unit portion 9, the operation portion left-case portion 29, and the operation portion right-case portion 49 are disposed in the operation portion unit 1. The non-contact portion 6 of the operation portion sub-base plate 4 is provided with a tap hole for screw-fastening the operation panel 7, the user USB connection portion 8, the operation portion left-case portion 29, and the operation portion right-case portion 49 disposed in the operation portion unit 1.

As shown in FIG. 7, the operation panel 7 is screw-fastened to the operation portion sub-base plate 4 by the screws 66 as fixing members.

FIG. 9A is a perspective view of the interior of the left side of the operation portion unit. As shown in FIG. 9A, the user USB connection portion 8 and the operation portion left-case portion 29 are screw-fastened to the operation portion sub-base plate 4 by screws 78 as fixing members.

FIG. 10A is a perspective view of the interior of the right side of the operation portion unit. As shown in FIG. 10A, the operation portion right-case portion 49 is screw-fastened to the operation portion sub-base plate 4 by screws 87 as fixing members.

The operation portion right case 50 having the bottom surface of the operation portion right-case portion 49 has a self-tap 77 (FIG. 14B) for placing the power supply unit portion 9, and the power supply unit portion 9 is screw-fastened to the operation portion right case 50 by the screw 79 as a fixing member.

As described above, the operation portion unit 1 has a configuration in which the operation panel 7, the user USB connection portion 8, the operation portion left-case portion 29, and the operation portion right-case portion 49 to which the power supply unit portion 9 is fastened by the screw 79 are fixed to the operation portion sub-base plate 4 welded to the operation portion base plate 2 by the screws as fixing members. That is, the operation portion unit 1 has a configuration in which the operation panel 7 and the user access portion other than the operation panel are integrated.

Although a configuration has been described as an example in which the operation portion unit 1 has the operation panel 7, and has the user USB connection portion 8 and the power supply unit portion 9 as user access portions other than the operation panel, the present invention is not limited thereto. The user access portion is not limited to the operation panel 7, the user USB connection portion 8, and the power supply unit portion 9, and may include units such as an IC card reader, an NFC, and a keypad, as long as it is accessible by a user. In this case, the units included in the operation portion unit 1 are fixed to any of the operation portion sub-base plate 4, the operation portion left case 30, and the operation portion right case 50 by screw fastening or the like.

FIG. 14A is a schematic diagram of the screws 66, 78, 87, and 88 of the operation portion sub-base plate 4, the operation panel 7, the user USB connection portion 8, the operation portion left-case portion 29, and the operation portion right-case portion 49. As shown in FIG. 14A, the non-contact portion 6 between the operation portion base plate 2 and the operation portion sub-base plate 4 has a space 44. In addition, the operation panel 7, the user USB connection portion 8, the power supply unit portion 9, and the like are fixed to the upper surface of the non-contact portion 6 of the operation portion sub-base plate 4 by the screws 66, 78, 87, and 88 as fixing members. Accordingly, when the operation panel 7, the user USB connection portion 8, the power supply unit portion 9, and the like are screw-fastened to the operation portion sub-base plate 4, tips of the screws 66, 78, 87, and 88 as fixing members are disposed higher than the main body frame 3.

FIG. 14B is a schematic diagram of the screw 79 of the power switch support plate 43 of the power supply unit portion 9 and the operation portion right case 50. As shown in FIG. 14B, the power switch support plate 43 of the power supply unit portion 9 and the operation portion right case 50 of the operation portion right-case portion 49 are fixed to the self-tap 77 provided in the bottom surface of the operation portion right case 50 by the screw 79 as a fixing member. In addition, the self-tap 77 (screw 79 as a fixing member) of the operation portion right case 50 for the power supply unit portion 9 is disposed higher than the operation portion sub-base plate 4.

As above, the non-contact portion 6 between the operation portion base plate 2 and the operation portion sub-base plate 4 has the space 44, and the user access portion including the operation panel 7 of the operation portion unit 1 is fixed to the non-contact portion 6 of the operation portion sub-base plate 4 by the fixing members (screws 66, 78, 87, and 88). Due to such a configuration, when the operation portion unit 1 is moved, the tips of the screws 66, 78, 87, and 88 and the self-tap 77 (screw 79) are not in contact with the main body frame 3 and the main body sub-frames 10a and 10b, and do not hinder the movement of the operation portion unit 1.

In addition, prior to the movement of the operation portion unit 1, no operation of loosening or removing the screws of the operation portion sub-base plate 4, the operation panel 7, the user USB connection portion 8, the operation portion left-case portion 29, and the operation portion right-case portion 49 is performed. Therefore, the amount of work required when the operation portion unit 1 is moved can be reduced.

In the present embodiment, a configuration is adopted in which the non-contact portion 6 between the operation portion sub-base plate 4 and the operation portion base plate 2 has the space 44 as shown in FIG. 14A, but the present invention is not limited thereto. For example, as shown in FIG. 14C, one component having surfaces with different heights may be provided. FIG. 14C is a schematic diagram of another example of the screws 66, 78, 87, and 88. In this case, as a base plate fixed to the main body frame 3, the operation portion unit has a first surface and a second surface provided above the first surface in the vertical direction. Specifically, by placing a hat-bent-shaped portion 76 on the base plate, the base plate has a contact portion (first surface) 5 in which surfaces of the base plate and the main body frame 3 are in contact with each other, and a non-contact portion (second surface) 6 in which the surfaces of the base plate and the main body frame 3 are not in contact with each other and which has a space 44. In addition, the non-contact portion (second surface) 6 of the base plate is provided with a tap hole for fixing the operation panel 7, the user USB connection portion 8, the operation portion left-case portion 29, and the operation portion right-case portion 49 by the screw. In addition, the operation panel 7 and the user access portion of the operation portion unit 1 are fixed to the non-contact portion (second surface) 6 by the screws 66, 78, 87, and 88 as fixing members. Accordingly, tips of the screws 66, 78, 87, and 88 are disposed higher than the main body frame 3 and the main body sub-frames 10a and 10b. Due to such arrangement, when the operation portion unit 1 is moved, the tips of the screws 66, 78, 87, and 88 are not in contact with the main body frame 3 and the main body sub-frames 10a and 10b, and the operation portion unit 1 can be rotationally moved.

The tips of all the screws (fixing members) do not need to be disposed higher than the main body frame 3, and at least one screw (fixing member) may be disposed higher than the main body frame 3 and the main body sub-frames 10a and 10b.

### (Movement of Operation Portion Unit)

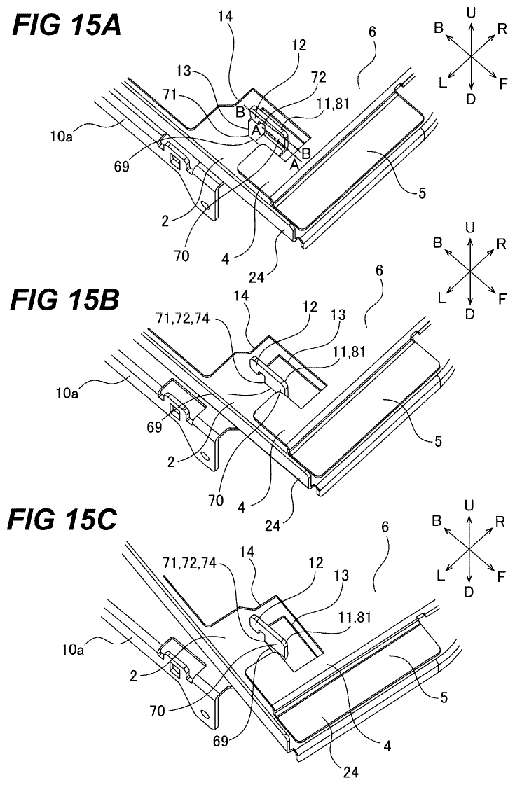

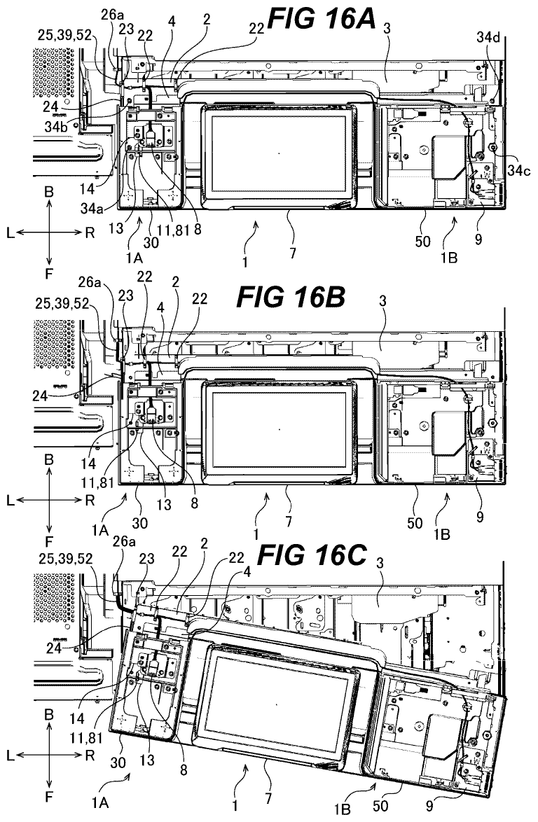

Next, a configuration of the movement of the operation portion unit from the first position to the second position with respect to the main body of the image forming apparatus will be described with reference to FIGS. 15A, 15B, 15C, 16A, 16B, and 16C.

The operation portion unit 1 is held so as to rotationally move between the first position and the second position with respect to the main body (main body frame 3) of the image forming apparatus. When moving from the first position to the second position, the operation portion unit 1 horizontally moves from the first position shown in FIG. 16A to the position shown in FIG. 16B, and then rotationally moves to the second position shown in FIG. 16C.

FIGS. 16A, 16B, and 16C are diagrams showing the operation portion unit 1 in which the original reading device front cover 59 and the upper cover 61 are removed. FIG. 16A is a diagram showing the operation portion unit 1 at the first position before movement. FIG. 16B is a diagram showing the operation portion unit 1 before rotation, that is, the operation portion unit 1 moved to a rotation center. FIG. 16C is a diagram showing the operation portion unit 1 at the second position after rotation.

As shown in FIG. 13, the main body sub-frame 10a as a chassis of the main body of the image forming apparatus has a rotational support portion 81 provided to protrude upward in the vertical direction. The rotational support portion 81 is disposed in the main body sub-frame 10a of the main body frame 3, and holds the operation portion unit 1 so as to rotationally move the operation portion unit 1 between the first position and the second position.

The rotational support portion 81 has a bent portion 11 as an axial portion and a protrusion portion 12 as a restriction portion. The bent portion 11 as a rotation axis of the rotational support portion 81 is along the vertical direction in a state in which an installation portion 101 of the main body of the image forming apparatus faces an installation surface 110 (state shown in FIGS. 2 and 4). The bent portion 11 is in contact with the operation portion unit 1 on one side of the center in the lateral direction of the operation portion unit, and serves as a rotation center (rotation axis). The protrusion portion 12 holds the one side of the operation portion unit 1 at the second position where the other side of the center in the lateral direction of the operation portion unit 1 is rotationally moved to the front side of the apparatus body relative to the first position. The protrusion portion 12 restricts the upward movement in the vertical direction of the operation portion unit 1 in contact with the bent portion 11, and holds the one side of the operation portion unit.

In other words, the operation portion unit 1 includes a first portion 1A and a second portion 1B (see FIGS. 16A to 16C). The first portion 1A of the operation portion unit 1 is a portion on one side of the center in the lateral direction of the operation portion unit 1 in a state in which the operation portion unit 1 is at the first position. The second portion 1B of the operation portion unit 1 is a portion on the other side of the center in the lateral direction of the operation portion unit 1 in a state in which the operation portion unit 1 is at the first position. The bent portion 11 as a rotation axis of the rotational support portion 81 is disposed in the first portion 1A of the operation portion unit 1. With the bent portion 11, as the operation portion unit 1 rotationally moves from the first position to the second position, the second portion 1B moves forward.

FIGS. 15A, 15B, and 15C are enlarged perspective views of the vicinity of the bent portion 11.

FIG. 15A shows the first position of the operation portion unit 1, FIG. 15B shows a position of the operation portion unit 1 before rotational movement, which is a position after horizontal movement, and FIG. 15C shows the second position of the operation portion unit 1 after rotational movement.

As shown in FIG. 15A, the operation portion unit 1 has an opening 13 and a cutout portion 14 at positions avoiding the bent portion 11 on the apparatus body side, when the operation portion unit 1 at the first position is viewed from above in the vertical direction. The opening 13 is disposed in the operation portion base plate 2, and is disposed at a position avoiding the bent portion 11 of the main body sub-frame 10a. The cutout portion 14 is disposed in the operation portion sub-base plate 4, and is disposed at a position avoiding the bent portion 11.

As shown in FIG. 15B, the operation portion unit 1 is moved in the horizontal direction from the first position to a position in contact with the bent portion 11 before rotational movement, and the opening 13 of the operation portion base plate 2 abuts on the bent portion 11 of the main body sub-frame 10a. After the abutment, the operation portion unit 1 is rotated about the contact portion between the bent portion 11 and the opening 13 as shown in FIG. 15C. In short, the contact portion between the bent portion 11 and the opening 13 serves as a rotation center 74 of the operation portion unit 1 during the rotational movement.

As shown in FIG. 15A, the rotational support portion 81 is provided to protrude upward in the vertical direction from the upper surface of the main body sub-frame 10a, and the protrusion portion 12 is disposed behind the bent portion 11. In the rotational support portion 81, a cross-sectional area B-B of the front end in the horizontal direction is made larger than a cross-sectional area A-A of the horizontal cross section of the base. This prevents the opening 13 of the operation portion base plate 2 from being removed from the bent portion 11 when the operation portion unit 1 rotationally moves.

Specifically, when the operation portion unit 1 is tilted toward the near side during the rotational movement of the operation portion unit 1, a portion of the operation portion base plate 2 outside the opening 13 is caught by the protrusion portion 12, so that the operation portion unit 1 can be prevented from falling from the main body of the image forming apparatus.

In the present embodiment, the rotational support portion 81 (bent portion 11) serving as the rotation center of the operation portion unit 1 is disposed in the main body sub-frame 10a as a chassis of the main body of the image forming apparatus. However, the position where the rotational support portion 81 is disposed is not limited to the main body sub-frame 10a as a chassis of the main body of the image forming apparatus, and may be the main body frame 3 or a unit other than the chassis.

In addition, the shape of the rotational support portion 81 is not limited to the bent portion 11 having the shape shown in FIG. 15A. The rotational support portion 81 may have a cylindrical shape, a prismatic shape, or the like. In that case, the cross-sectional area B-B of the front end of the rotational support portion 81 may also be made larger than the cross-sectional area A-A of the base, to prevent the operation portion unit 1 from falling. Alternatively, a screw or the like in which the cross-sectional area B-B of the front end is larger than the cross-sectional area A-A of the base may be used as the rotational support portion 81.

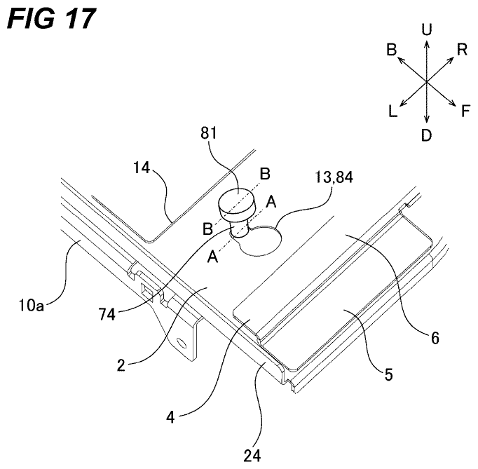

In a case where a screw is used as the rotational support portion 81, the rotational support portion 81 may also fasten the operation portion unit 1 to the main body of the image forming apparatus. In that case, when the operation portion unit 1 rotationally moves to the second position, the screw (rotational support portion) is loosened to rotationally move the operation portion unit 1. In addition, the shape of the opening 13 of the operation portion base plate 2 is not limited to a polygon, and may be a round hole, a teardrop hole, a long round hole, or the like. FIG. 17 shows a diagram in a case where the shape of the rotational support portion 81 is cylindrical and the shape of the opening 13 of the operation portion base plate 2 is a teardrop hole 84. Even with such a configuration, the same effects as those of the configuration shown in FIGS. 15A to 15C can be expected.

Next, a procedure when the operation portion unit 1 moves from the first position to the second position will be described.

The screw of the upper cover 61 with respect to the main body of the image forming apparatus is removed, and the upper cover 61 is removed from the main body of the image forming apparatus. By removing the upper cover 61 from the main body of the image forming apparatus, it is possible to access a screw 65 (FIG. 8) on the side surface of the original reading device front cover 59, and the upper cover 61 and the operation portion unit 1 do not interfere with each other when the operation portion unit 1 rotationally moves.

After the upper cover 61 is removed, the screw 65 of the original reading device front cover 59 with respect to the main body of the image forming apparatus is removed, and the original reading device front cover 59 is removed from the main body of the image forming apparatus. By removing the original reading device front cover 59 from the main body of the image forming apparatus, it is possible to access the screws 34b and 34d (FIG. 16A) that fasten the operation portion base plate 2 to the main body frame 3, and the original reading device front cover 59 and the operation portion unit 1 do not interfere with each other when the operation portion unit 1 rotationally moves.

The snap fit 35 of the operation portion left lid 31 is bent to release the engagement between the operation portion left case 30 and the projection portion 38, and the operation portion left lid 31 is removed from the operation portion left case 30. By removing the operation portion left lid 31 from the operation portion left case 30, it is possible to access the screw 34a (FIG. 9A) that fastens the operation portion base plate 2 to the main body frame 3.

The snap fit 55 of the operation portion right lid 51 is bent to release the engagement between the operation portion right case 50 and the projection portion 58, and the operation portion right lid 51 is removed from the operation portion right case 50. By removing the operation portion right lid 51 from the operation portion right case 50, it is possible to access the screw 34c (FIG. 10A) that fastens the operation portion base plate 2 to the main body frame 3.

As described above, by removing the original reading device front cover 59 and the upper cover 61, a space is secured when the operation portion unit 1 rotationally moves. In addition, removing the original reading device front cover 59, the operation portion left lid 31, and the operation portion right lid 51 from the main body of the image forming apparatus enables access to the screws 34a to 34d that fasten the operation portion unit 1 to the main body sub-frames 10a and 10b.

Next, in order to move the operation portion unit 1 with respect to the main body of the image forming apparatus, the screws 34a to 34d that fasten the operation portion unit 1 to the main body sub-frames 10a and 10b are removed. By removing the screws 34a to 34d, the operation portion unit 1 can be moved with respect to the main body of the image forming apparatus.

After the screws are removed, the operation portion unit 1 is moved to the rotation center and rotated as follows.

First, the operation portion unit 1 that is movable with respect to the main body of the image forming apparatus is moved in the horizontal direction from the first position to a position in contact with the rotational support portion 81. Specifically, the operation portion unit 1 is moved to a position where a left end surface 69 of the opening 13 of the operation portion base plate 2 shown in FIG. 15A and a left side surface 70 of the bent portion 11 of the main body sub-frame 10a are in contact with each other, and an edge line 71 of the opening 13 of the operation portion base plate 2 and an edge line 72 of the left side surface 70 of the bent portion 11 of the main body sub-frame 10a are in contact with each other (FIG. 15B). Then, the operation portion unit 1 is rotated clockwise when the image forming apparatus is viewed from above about the contact portion between the edge line 72 of the bent portion 11 and the edge line 71 of the opening 13 (FIG. 15C).

The rotation center is provided on the left side of the operation portion unit 1. Therefore, in a case where the operation portion unit 1 is rotated clockwise, a space is formed between the right side of the operation portion unit 1 and the original reading device 105 as shown in FIG. 16C, and an operator can access the inside of the main body of the image forming apparatus.

The image forming apparatus of the present embodiment is a monochrome image forming apparatus shown in FIG. 4. In the monochrome image forming apparatus shown in FIG. 4, the image forming portion 102 as a maintenance portion is disposed on the side opposite to the side on which the rotational support portion 81 as a rotation center of the operation portion unit 1 is disposed in the lateral direction. Therefore, when the operation portion unit 1 rotationally moves about the rotational support portion 81 as a rotation center, with the side on which the image forming portion 102 is disposed being on the front side, a space can be formed between the right side of the operation portion unit 1 and the original reading device 105. Therefore, an operator can access the laser scanner 203 of the image forming portion 102 shown in FIG. 4 from the above-described space. In addition, since the left side of the operation portion unit 1 is held by the rotational support portion 81 at the second position, the operation portion unit 1 can be prevented from falling from the apparatus body.

In the present embodiment, a configuration is adopted in which when the operation portion unit 1 is rotated clockwise with the rotation center 74 of the operation portion unit 1 being on the left side, a space for accessing the maintenance portion is formed between the right side of the operation portion unit 1 and the original reading device 105. However, the present invention is not limited thereto, and a configuration may be adopted in which the operation portion unit 1 is rotated counterclockwise with the rotation center 74 of the operation portion unit 1 being on the right side. Even with this configuration, a space for accessing the maintenance portion can be formed between the left side of the operation portion unit 1 and the original reading device 105.

Next, a distance by which the cable holding portion 23 moves when the operation portion unit 1 is rotationally moved with respect to the apparatus body will be described.

As shown in FIGS. 13 and 16A, the cable holding portion 23 disposed on the operation portion base plate 2 is disposed near the rotational support portion 81 (bent portion 11) serving as the rotation center 74 of the operation portion unit 1. The cable holding portion (first cable holding portion) 23 is disposed in the first portion 1A of the operation portion unit 1. In addition, the cable holding portion 23 is disposed at a position where the cables 25, 39, and 52 of the operation portion unit 1 shown in FIG. 7 extend over the operation portion unit 1 and the main body of the image forming apparatus.

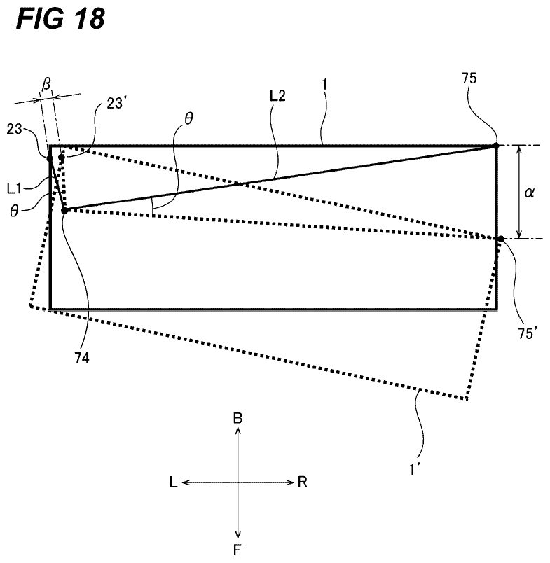

FIG. 18 is a diagram schematically showing the operation portion unit 1, the cable holding portion 23, the rotation center 74, and a right rear end 75 of the operation portion unit 1 near the access space. In FIG. 18, the operation portion unit 1 at the first position is indicated by the solid line, and the operation portion unit 1 at the second position is indicated by the dotted line.

A moving distance β from the cable holding portion 23 at the first position to a cable holding portion 23′ at the second position can be calculated through the following Formula (1), where l denotes a distance from the rotation center 74 to the cable holding portion 23 at the first position, and θ denotes a rotation angle of the operation portion unit 1.

$$β = 2 \times 1 \times sin ( θ / 2 ) \qquad ( 1 )$$

In a case where a distance L1 from the rotation center 74 to the cable holding portion 23 at the first position is 100 mm and the rotation angle θ is 10 degrees, the moving distance β is about 17 mm.

Meanwhile, a moving distance α from the right rear end 75 at the first position to a right rear end 75′ at the second position of the operation portion unit 1 can be calculated through the following Formula (2), where L denotes a distance from the rotation center 74 to the right rear end 75 at the first position.

$$α = 2 \times L \times sin ( θ / 2 ) \qquad ( 2 )$$

In a case where a distance L2 from the rotation center 74 to the right rear end 75 at the first position is 600 mm and the rotation angle θ is 10 degrees, the moving distance α is about 105 mm.

As above, the moving distance of the cable holding portion 23 can be limited to about 17 mm while the operation portion unit 1 is moved by about 105 mm with the access space at the right rear.

There is a concern that the cables 25, 39, and 52 may be pulled by the moving distance of the cable holding portion 23 of 17 mm and may break. However, as shown in FIG. 8, when the cables 25, 39, and 52 of the operation portion unit 1 between the cable holding portion 23 and the cable holding portion 26a have a curved portion 73a, the moving distance of 17 mm can be subtracted.

Details thereof will be described below.

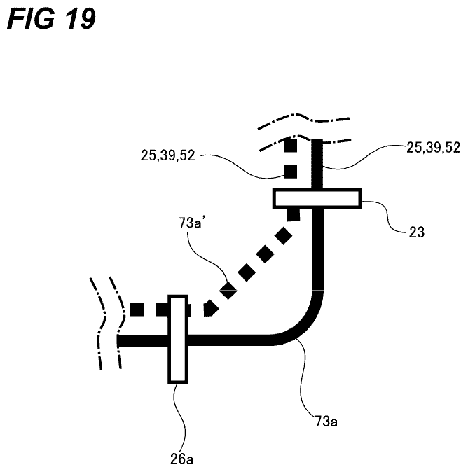

FIG. 19 shows a schematic diagram of the cable holding portion 23, the cable holding portion 26a, and the cables 25, 39, and 52 between the cable holding portions 26a and 23. In FIG. 19, the solid line indicates the cables 25, 39, and 52 when the operation portion unit 1 is at the first position, and the dotted line indicates the cables 25, 39, and 52 when the operation portion unit 1 is at the second position.

The cable holding portion (second cable holding portion) 26a is disposed in the main body of the image forming apparatus. The cable holding portion 26a is disposed at a position closest to the cable holding portion (first cable holding portion) 23. The cable holding portion 26a holds the cables 25, 39, and 52, which are held by the cable holding portion 23 and extend over the main body of the image forming apparatus and the operation portion unit 1, at the position closest to the cable holding portion 23.

The cable holding portion 23 disposed on the operation portion unit side is a first holding portion that has a passing space for the cable in the lateral direction (first direction) and holds the cable in the passing space. The cable holding portion 26a disposed on the image forming apparatus main body side is a second holding portion that has a passing space for the cable in the front-rear direction (second direction) intersecting with the lateral direction and holds the cable in the passing space.

As shown in FIG. 19, when the operation portion unit 1 is at the first position, the cables 25, 39, and 52 between the cable holding portion 23 and the cable holding portion 26a have a curved portion 73a. When the operation portion unit 1 is at the second position, the curved portions 73a of the cables 25, 39, and 52 between the cable holding portions 26a and 23 become linear portions 73a′ that are substantially linear and connect the cable holding portion 23 and the cable holding portion 26a.

The curved portion 73a of the cable has such a length as to be linear at least between the cable holding portion 23 and the cable holding portion 26a when the operation portion unit 1 is at the second position. The curved portion 73a of the cable is longer than a linear length between the cable holding portion 23 and the cable holding portion 26a when the operation portion unit 1 is at the first position. The curved portion 73a of the cable at least has a length obtained by adding a moving distance of the cable holding portion 23 from the first position to the second position to a linear length between the cable holding portions 23 and 26a when the operation portion unit 1 is at the first position.

With this configuration, it is possible to shorten the passing distances of the cables 25, 39, and 52 between the cable holding portion 23 and the cable holding portion 26a when the operation portion unit 1 is rotationally moved.

Furthermore, the cable-passing spaces of the cable holding portions 26a and 23 are larger than the diameters of the cables 25, 39, and 52. Therefore, the cables 25, 39, and 52 move in the cable holding portions 23 and 26a even in a case where the cables 25, 39, and 52 are pulled toward the operation portion unit 1 side due to the rotational movement of the operation portion unit 1. Accordingly, it is possible to shorten the passing distances of the cables between the cable holding portion 23 and the cable holding portion 26a.

In addition, in the cable, a plurality of curved portions is disposed in addition to the above-described curved portion 73a of the cable between the cable holding portions 26a and 23. Examples thereof include curved portions 73b to 73d of the cable between the cable holding portions on the side surface of the image forming apparatus, shown in FIG. 8, and curved portions 73e to 73g of the cable between the cable holding portions of the operation portion unit 1, shown in FIG. 7. It is possible to shorten the passing distances of the cables of the operation portion unit 1 also in the curved portions 73b to 73d and the curved portions 73e to 73g, similarly to the above-described curved portion 73a.

As above, even in a case where the cable between the cable holding portions 26a and 23 is pulled due to the movement of the cable holding portion 23 on the operation portion unit 1 side with respect to the cable holding portion 26a on the apparatus body side, a break can be avoided by changing the passing position of the cable.

In the present embodiment, no space is provided for placing the extra length of the cable of the operation portion unit, but a space may be provided for placing the extra length of the cable of the operation portion unit.

Next, positions of the cable holding portion 23 of the operation portion unit 1 and the cable holding portion 26a of the main body of the image forming apparatus will be described.

As shown in FIG. 13, the cable holding portion 26a of the main body of the image forming apparatus is disposed near the cable holding portion 23 of the operation portion unit 1. A distance between the cable holding portion 26a of the main body of the image forming apparatus and the cable holding portion 23 of the operation portion unit 1 is desirably short, and is desirably within about 300 mm. Due to such arrangement, when other units or the like are attached to the image forming apparatus, the cables 25, 39, and 52 of the operation portion unit 1 can be avoided from being broken due to being nipped by other units or the like.

In the present embodiment, it is desirable that the distance from the rotational support portion 81 (bent portion 11) serving as the rotation center 74 to the cable holding portion 23 is about 100 mm, and the distance from the cable holding portion 23 to the cable holding portion 26a of the main body of the image forming apparatus is within 300 mm. Therefore, the distance from the rotational support portion 81 serving as the rotation center 74 to the cable holding portion 26a of the main body of the image forming apparatus may be within 400 mm.

In the present embodiment, the rotation angle θ (see FIG. 18) of the operation portion unit 1 is 10 degrees, but the rotation angle θ is not limited thereto, and may be 90 degrees or the like. In this case, not only a part of the deep side of the operation portion unit 1 but also the entire deep side of the operation portion unit 1 can be set as the access space.

As described above, according to the present embodiment, it is possible to allow the operation portion unit to move between the first position and the second position with a simple configuration, and thus it is possible to improve the workability associated with the movement of the operation portion unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210184, filed Dec. 3, 2024, which is hereby incorporated by reference herein in its entirety.

What is claimed is:

1. An image forming apparatus comprising:
an apparatus body;
an operation portion unit including an operation portion configured to input a signal to the apparatus body; and
a rotational support portion disposed in the apparatus body and configured to support rotationally the operation portion unit so that the operation portion unit pivots between a first position and a second position around a rotation axis of the rotational support portion,
wherein the rotation axis of the rotational support portion is directed in a vertical direction in a state in which an installation portion of the apparatus body faces an installation surface.

2. The image forming apparatus according to claim 1,
wherein the operation portion unit includes
a first portion on a first side of a center in a lateral direction of the operation portion unit in a state in which the operation portion unit is at the first position, and
a second portion on a second side of the center in the lateral direction of the operation portion unit in a state in which the operation portion unit is at the first position, the second side being opposite to the first side with respect to the center in the lateral direction,
the rotation axis of the rotational support portion is disposed in the first portion of the operation portion unit, and
the second portion moves forward as the operation portion unit pivots from the first position to the second position.

3. The image forming apparatus according to claim 2, further comprising:
a cable configured to electrically connect the apparatus body and the operation portion;
a first cable holding portion disposed in the first portion of the operation portion unit and configured to hold the cable; and
a second cable holding portion disposed in the apparatus body and configured to hold the cable,
wherein a distance between the second cable holding portion and the rotation axis of the rotational support portion is within 400 mm.

4. The image forming apparatus according to claim 1,
wherein the operation portion unit further includes a user access portion, and
the operation portion and the user access portion integrally move around the rotation axis.

5. The image forming apparatus according to claim 4,
wherein the operation portion unit has
a base plate fixed to the apparatus body, and
a sub-base plate disposed on an upper surface of the base plate and fixed to the base plate,
the sub-base plate has a contact portion in contact with the base plate and a non-contact portion having a space without being in contact with the base plate,
the user access portion of the operation portion unit is fixed to the non-contact portion of the sub-base plate by a fixing member, and
the fixing member fixed to the non-contact portion of the sub-base plate is kept to be apart from the apparatus body during the pivot of the operation portion unit.

6. The image forming apparatus according to claim 4,
wherein the operation portion unit has a base plate fixed to the apparatus body,
the base plate has a first surface and a second surface provided above the first surface in the vertical direction,
the user access portion of the operation portion unit is fixed to the second surface by a fixing member, and
the fixing member fixed to the second surface is kept to be apart from the apparatus body during the pivot of the operation portion unit.

7. The image forming apparatus according to claim 1,
wherein the rotational support portion is provided to protrude upward in the vertical direction from an upper surface of the apparatus body, and a cross-sectional area of a horizontal cross section of a front end is larger than a cross-sectional area of a horizontal cross section of a base.

8. The image forming apparatus according to claim 1,
wherein the rotational support portion has
a shaft portion that is in contact with the operation portion unit and serves as the rotation axis, and
a restriction portion that restricts upward movement in the vertical direction of the operation portion unit in contact with the shaft portion.

9. The image forming apparatus according to claim 1,
wherein the operation portion unit is moved in a horizontal direction from the first position, and then rotationally moved about the rotation axis to the second position.

10. The image forming apparatus according to claim 8,
wherein the operation portion unit has an opening,
the opening is disposed at a position avoiding the rotational support portion when the operation portion unit at the first position is viewed from above in the vertical direction, and
a contact portion between the rotational support portion and the opening serves as a rotation center of the operation portion unit.

11. The image forming apparatus according to claim 2,
wherein the apparatus body has a maintenance portion therein,
the maintenance portion is disposed on a side opposite to a side on which the rotational support portion of the operation portion unit is disposed in the lateral direction, and
in the operation portion unit, the first portion of the operation portion unit is held by the rotational support portion at the second position where the side on which the maintenance portion is disposed is rotationally moved to a front side of the apparatus body relative to the first position.

12. The image forming apparatus according to claim 3,
wherein the cable has, between the first cable holding portion and the second cable holding portion, a curved portion that is longer than a straight line connecting the first cable holding portion and the second cable holding portion.

13. The image forming apparatus according to claim 12,
wherein passing spaces of the first cable holding portion and the second cable holding portion that hold the cable are larger than a diameter of the cable.

14. The image forming apparatus according to claim 12, further comprising:
a first holding portion having a passing space for the cable in a first direction and configured to hold the cable in the passing space; and
a second holding portion having a passing space for the cable in a second direction intersecting with the first direction and configured to hold the cable in the passing space,
wherein the cable between the first holding portion and the second holding portion has a curved portion.

15. The image forming apparatus according to claim 14,
wherein the curved portion has a length that is linear at least between the first holding portion and the second holding portion when the operation portion unit is at the second position.

16. The image forming apparatus according to claim 15, wherein a moving distance β of the first holding portion from the first position to the second position is calculated through β=2×l×sin(θ/2), where l denotes a distance from the rotational support portion to the first holding portion, and θ denotes a rotation angle of the operation portion unit.
